(19) United States
(12) Patent Application Publication
(10) Pub. No.: US 2014/0325803 A1
(43) Pub. Date: Nov. 6, 2014

(54) WEBBING MOUNTING ASSEMBLY

(71) Applicant: ILLINOIS TOOL WORKS INC., Glenview, IL (US)

(72) Inventors: Christopher A.J. Iannello, Rolling Meadows, IL (US); Martin J. Nilsen, Hampshire, IL (US)

(21) Appl. No.: 14/366,012

(22) PCT Filed: Dec. 14, 2012
(86) PCT No.: PCT/US2012/069681

§ 371 Date: Jun. 17, 2014

Related U.S. Application Data
(60) Provisional application No. 61/577,200, filed on Dec. 19, 2011.

(51) Int. Cl. A45F 5/00; F16B 2/20

(52) U.S. Cl. CPC A45F 5/00; F16B 2/20
USPC 24/460; 24/485

(57) ABSTRACT

A webbing mounting assembly is configured to secure an article to a webbing of a structure. The assembly may include a securing platform configured to securely retain the article, and a base connected to the securing platform. The base may include at least a first axis and a second axis that differs from the first axis, at least a first set of webbing retainers aligned with the first axis, and at least a second set of webbing retainers aligned with the second axis. The first set of webbing retainers and the second set of webbing retainers are configured to secure the article to the webbing in different orientations.

### RELATED APPLICATIONS

This application relates to and claims priority benefits from U.S. Provisional Patent Application No. 61/557,200 entitled “Web Mounting Assembly,” filed Dec. 19, 2011, which is hereby incorporated by reference in its entirety.

### FIELD OF EMBODIMENTS OF THE DISCLOSURE

Embodiments of the present disclosure generally relate to a webbing mounting assembly and, more particularly, to a webbing mounting assembly configured to allow articles to be mounted thereon.

### BACKGROUND

Backpacks and other such devices are typically worn by users in order to allow transport of items while maintaining mobility. Indeed, backpacks and the like are worn by soldiers during various military training and combat operations.

In military applications, for example, articles, such as devices, accessories, components, and the like, may be removably secured to a strap or webbing of a backpack, for example. Thus, an individual may quickly and easily remove and use an accessory, such as a firearm scope, and then reattach it to the webbing or strap when no longer in use.

However, mounting features on webbings or straps are typically configured for attachment in a particular orientation with respect to the webbings or straps. The orientation of such mounting features may lead to awkward attachment of devices, accessories, components, and the like, to the webbings or straps.

### SUMMARY OF EMBODIMENTS OF THE DISCLOSURE

Certain embodiments of the present disclosure provide a webbing mounting assembly configured to secure an article to a webbing of a structure. The assembly may include a securing platform configured to securely retain the article, and a base connected to the securing platform. The base may include at least a first axis and a second axis that differs from the first axis, at least a first set of webbing retainers aligned with the first axis, and at least a second set of webbing retainers aligned with the second axis. The first set of webbing retainers and the second set of webbing retainers are configured to secure the article to the webbing in different orientations.

Each of the webbing retainers may include an insertion channel connected to a webbing-retaining slot. The insertion channel may be perpendicular to the webbing-retaining slot. In another embodiment, the insertion channel connects to the webbing-retaining slot at an angle other than 90°.

The securing platform may include a plurality of alternating ridges and channels. The securing platform may be or include a tactical or Picatinny rail.

A first length of the base along the first axis may differ than a second length of the base along the second axis. The base may be rectangular, square-shaped, triangular, circular, or various other shapes.

Certain embodiments of the present disclosure provide a webbing mounting assembly that may include a base configured to retain a portion of the webbing. The base may include at least a first axis and a second axis that differs from the first axis, at least a first set of webbing retainers aligned with the first axis, and at least a second set of webbing retainers aligned with the second axis. The first set of webbing retainers and the second set of webbing retainers are configured to secure the article to the webbing in different orientations.

### BRIEF DESCRIPTION OF SEVERAL VIEWS OF THE DRAWINGS

FIG. 1 illustrates an isometric top view of a webbing mounting assembly, according to an embodiment of the present disclosure.

FIG. 2 illustrates a cross-sectional view of a ridge of a securing platform of a webbing mounting assembly, according to an embodiment of the present disclosure.

FIG. 3 illustrates an end view of a securing platform of a webbing mounting assembly, according to an embodiment of the present disclosure.

FIG. 4 illustrates a top view of webbing mounting assemblies secured to webbing, according to an embodiment of the present disclosure.

FIG. 5 illustrates an isometric top view of articles secured to webbing mounting assemblies that are secured to webbings of a structure, according to an embodiment of the present disclosure.

FIG. 6 illustrates an axial cross-sectional view of a base of a webbing mounting assembly, according to an embodiment of the present disclosure.

FIG. 7 illustrates an axial cross-sectional view of a base of a webbing mounting assembly, according to an embodiment of the present disclosure.

FIG. 8 illustrates an axial cross-sectional view of a base of a webbing mounting assembly, according to an embodiment of the present disclosure.

FIG. 9 illustrates a top plan view of a webbing retainer, according to an embodiment of the present disclosure.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

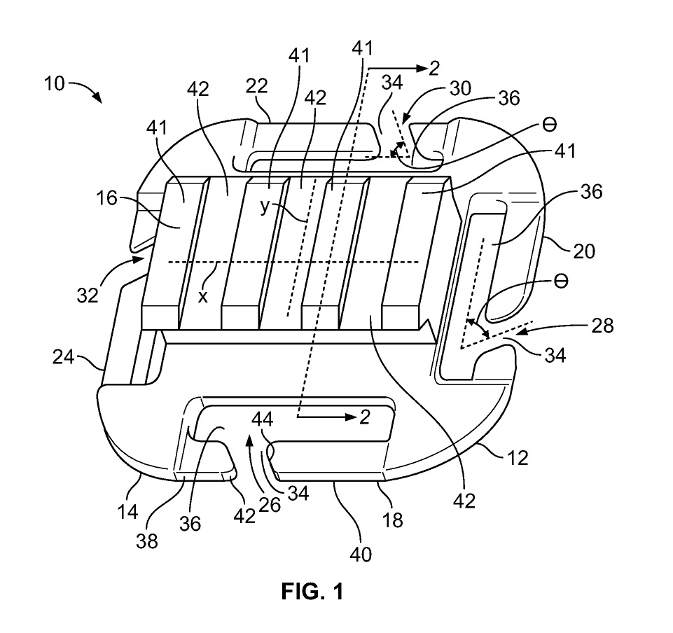

FIG. 1 illustrates an isometric top view of a webbing mounting assembly 10, according to an embodiment of the present disclosure. The assembly 10 includes a main body 12 having a base 14 that supports a securing platform 16. The main body 12, including the base 14 and the securing platform 16, may be integrally formed and manufactured as a single piece. For example, the assembly 10 may be formed of injection-molded plastic. Optionally, the assembly 10 may be formed of metal. Alternatively, the assembly 10 may be formed of plastic and metal. For example, the base 14 may be formed of metal, while the securing platform 16 is formed of plastic, or vice versa.

The base 14 is configured to be secured to a webbing, strap, or the like, in multiple orientations. As shown in FIG. 1, the base 14 includes four sides 18, 20, 22, and 24. The base 14 may be generally formed as a rectangle, with the sides 18 and 22 being longer than the sides 20 and 24, or vice versa. However, the base 14 may be formed in various other shapes and sizes, such as a square, circle, triangle, hexagon, octagon, parallelogram, trapezoid, or the like.

Webbing retainers 26, 28, 30, and 32 are formed in the sides 18, 20, 22, and 24, respectively. Each webbing retainer 26, 28, 30, and 32 includes an insertion channel 34 connected to a webbing-retaining slot 36. As shown, the insertion channel 34 is defined by cross beams 38 and 40 that extend toward one another, and are generally parallel with the webbing-retaining slot 36. The insertion channel 34 may be generally perpendicular to the webbing-retaining slot 36. However, terminal ends 42 and 44 of the cross beams 38 and 40, respectively, may be angled, canted, or otherwise sloped with respect to the webbing-retaining slot 36. The terminal ends 42 and 44 may be parallel with one another, thereby defining an angle of the insertion channel 34. The insertion channel 34 may be formed at an angle θ with respect to the webbing-retaining slot 36. The angle θ may be less than 90°. For example, the angle θ may be between 45° to 75°. However, the angle θ may be various other angles that are equal to, greater or less than 90°.

In operation, an edge of a webbing or strap is inserted into the insertion channel 34 and manipulated into the webbing-retaining slot 36, until an entire width of the webbing or strap is located into the webbing-retaining slot 36 (see, for example, FIG. 4). Once the webbing or strap is positioned in the webbing-retaining slot 36, the angle θ of the insertion channel 34, which may be less than 90°, prevents the webbing or strap from inadvertently retreating into the insertion channel 34 and out of the webbing retainer 26, 28, 30, or 32. In order to remove the webbing or strap from the webbing retainer 26, 28, 30, or 32, an individual manipulates the webbing or strap through a removal procedure. For example, the individual may grasp the webbing or strap and direct an edge of the strap into the insertion channel 34, and then pull the webbing or strap out therethrough.

As noted, each side 18, 20, 22, and 24 of the base 14 includes a webbing retainer 26, 28, 30, and 32, respectively, formed therethrough. Accordingly, the webbing mounting assembly 10 may be secured to a webbing or strap in different orientations. For example, the webbing mounting assembly 10 may be secured to a webbing or strap along a lateral axis X, or along a longitudinal axis Y, which may be perpendicular to the lateral axis X. The webbing mounting assembly 10 may include more or less webbing retainers than those shown. For example, each side 18, 20, 22, and 24 may include multiple webbing retainers, which may be smaller than the webbing retainers shown. Additionally, the webbing mounting assembly 10 may be longer along each axis X and Y, to accommodate more webbing retainers. Further, the webbing mounting assembly 10 may be various other shapes and sizes with one or more webbing retainers at each distinct side.

The base 14 supports the securing platform 16, which extends upwardly from the base 14. The securing platform 16 is configured to removably retain a wide variety of articles, such as devices, components, accessories, accoutrements, and the like. The securing platform 16 includes a plurality of ridges 41 separated by channels 42, thereby forming a series of peaks and valleys on the securing platform 16. As shown in FIG. 1, the securing platform 16 may include four ridges 41 and three channels 42. The ridges 41 and channels 42 are aligned with (for example, parallel with) the longitudinal axis Y. Alternatively, the ridges 41 and channels 42 may be aligned with the lateral axis X. Also, alternatively, the ridges and channels 42 may be oriented differently, such that they are not aligned with either the axes X or Y.

The ridges 41 and channels 42 are configured to interface with reciprocal channels and ridges formed on securing bases of articles, such as devices, components, accessories, accoutrements, and the like, in order to retain the articles thereto. The securing platform 16 allows for interchangeable attachment of articles thereto. The securing platform 16 may be a Picatinny rail, otherwise known as a tactical rail, for example, which may be used with Modular Lightweight Load-carrying Equipment (MOLLE) systems, for example. The webbing mounting assembly 10 may be configured to provide an interface between webbing in a MOLLE system and a Picatinny rail platform, for example.

MOLLE systems provide load-bearing equipment and rucksacks used by the United States armed forces, for example. MOLLE systems are modular and may be used in conjunction with Pouch Attachment Ladder System (PALS) webbing. PALS webbing generally includes rows of heavy-duty nylon stitched onto a load-bearing platform, such as a vest, backpack, or the like, and is configured to allow for attachment of various MOLLE-compatible pouches and accessories.

A MOLLE system may include a tactical assault panel, rucksack, hydration bladder, and modular pouches. The tactical assault panel may be a bib-like component worn on a chest. The tactical assault panel may be covered with PALS webbing. The rucksack may also include PALS webbing at certain locations. The hydration bladder replaces separate and distinct canteens. The modular pouches may be attached to the PALS webbing at various locations on the MOLLE system. For example, one type of modular pouch may hold one or more Meal(s), Ready to Eat (MREs).

A Picatinny rail may include a bracket used on some firearms, for example, in order to provide a standardized mounting platform, which may be used to mount accessories such as scopes, grenade launchers, and the like. A Picatinny rail may include a series of ridges, such as the ridges 41, having a T-shaped cross-section separated by flat spacing slots, such as the channels 42. Scopes, for example, may be mounted either by sliding them on the rail from an end, through a weaver mount that is clamped to the rail with bolts, thumbscrews, levers, or the like, or onto slots between ridges. A Picatinny rail may be used with various accessories, such as scopes, tactical lights, laser aiming modules, grenade launchers, night vision devices, reflex sights, foregrips, bipods, and bayonets. Picatinny rails may have standardized dimensions, such as a slot width of 0.206″ (5.23 mm), spacing between slot centers of 0.394″ (10.01 mm) and slot depth of 0.118″ (3.00 mm). In this manner, the Picatinny rails are configured to accommodate interchangeable accessories.

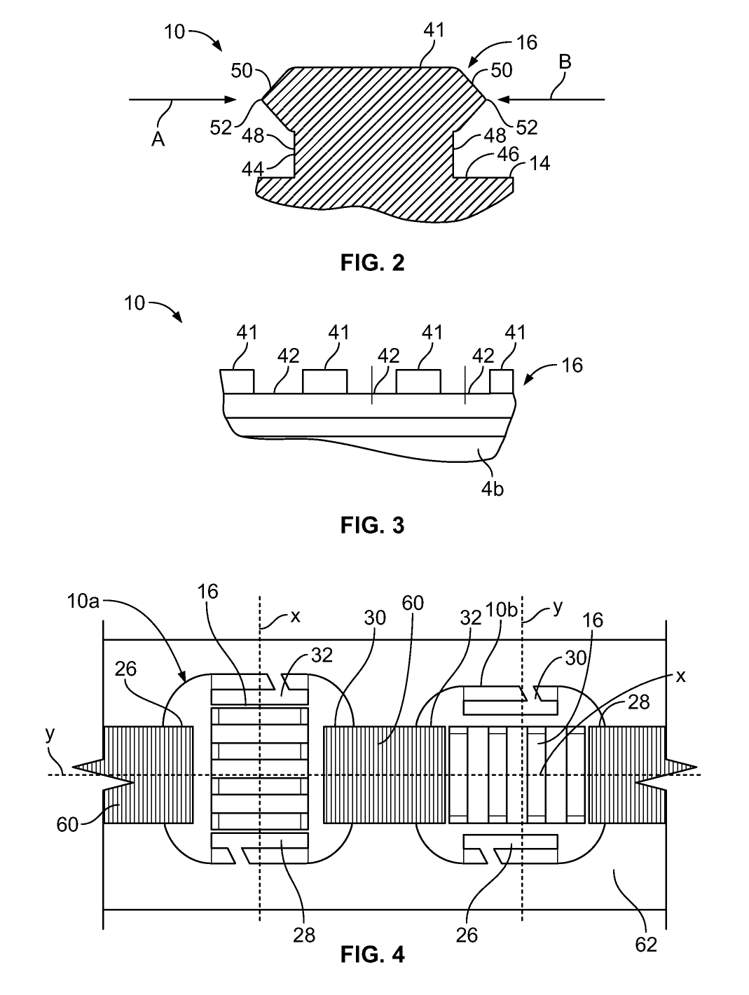

FIG. 2 illustrates a cross-sectional view of a ridge 41 of the securing platform 16 of the webbing mounting assembly 10, according to an embodiment of the present disclosure. FIG. 3 illustrates an end view of the securing platform 16 of the webbing mounting assembly 10, according to an embodiment of the present disclosure. Referring to FIGS. 2 and 3, the securing platform 16 may include an extension 44 that upwardly extends from a top surface 46 of the base 14. The extension 44 may generally be linear, having straight, vertical ends 48 that are perpendicular to the top surface 46. The extension 44 integrally connects to the ridge(s) 41. Each ridge 41 may include terminal ends 50 that outwardly extend from a vertical plane in which the extension 44 resides. The terminal ends 50 may include beveled or otherwise inwardly-angled tips 52. In order to secure an article to the securing platform 16, the reciprocal securing base of the article is aligned with the securing platform 16 such that the ridges 41 of the securing platform 16 align with reciprocal slots of the securing base of the article, and channels 42 of the securing platform 16 align with ridges of the securing base of the article. The article may then be urged onto the securing platform 16 in the directions of arrows A or B, for example. In order to remove the article from the securing platform 16, the article is urged off the securing platform in an opposite direction.

FIG. 4 illustrates a top view of webbing mounting assemblies 10a and 10b secured to a webbing 60, according to an embodiment of the present disclosure. The webbing 60 is secured to a structure 62, such as a backpack, rucksack, MOLLE system, or the like. The webbing retainers 26, 28, 30, and 32 positioned at sides 18, 20, 22, and 24, respectively, allow the webbing mounting assemblies 10a and 10b to be secured to the webbing 60 at different orientations. As shown in FIG. 4, the webbing mounting assembly 10a secures to the webbing 60 along the longitudinal axis Y, while the webbing mounting assembly 10b secures to the webbing 60 along the lateral axis X. In this manner, an individual may orient the webbing mounting assemblies 10a and 10b in order to accommodate various articles at desired positions. The webbing mounting assemblies 10a and 10b may be removed from the webbing 60 and re-secured thereto at different orientations than those shown. For example, the webbing mounting assembly 10a may be removed from the webbing 60 and re-secured to the webbing 60 so that the webbing mounting assembly 10a secures to the webbing 60 along the lateral axis X.

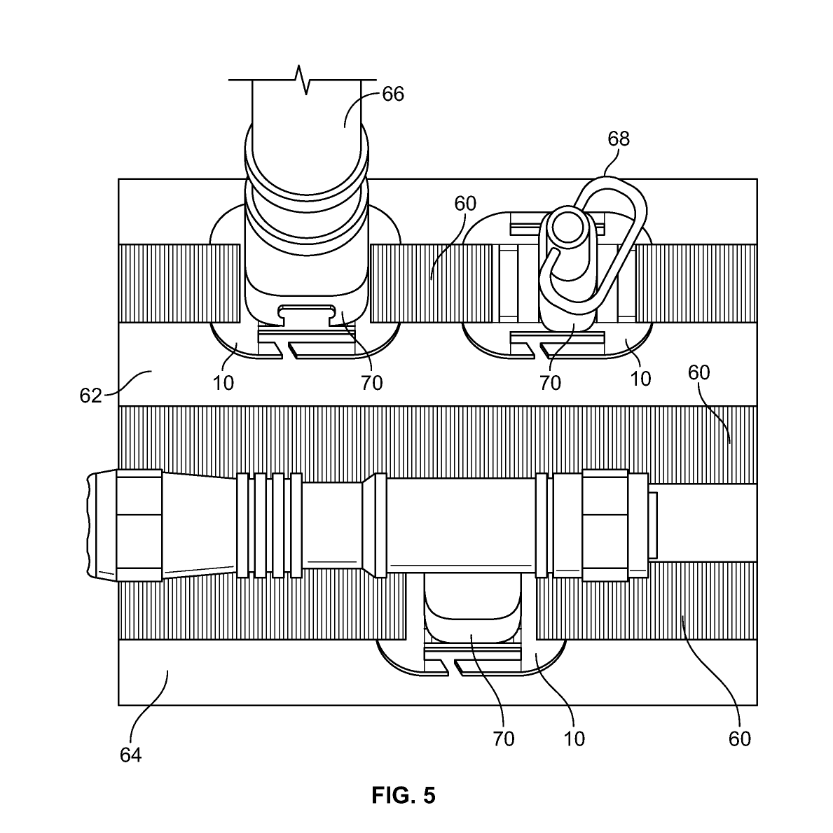

FIG. 5 illustrates an isometric top view of articles 64, 66, and 68 secured to webbing mounting assemblies 10 that are secured to webbings 60 of the structure 62, according to an embodiment of the present disclosure. The articles 64, 66, and 68 include securing bases 70 that are compatible with the securing platforms 16 (shown in FIGS. 1-3, for example) of the mounting assemblies 10. The articles 64, 66, and 68 may be interchangeably secured and removed from the mounting assemblies 10. The articles 64, 66, and 68 may be scopes, tactical lights, laser aiming modules, grenade launchers, night vision devices, reflex sights, foregrips, bipods, and bayonets, for example. When an individual desires to utilize one or more of the articles 64, 66, and 68, the individual removes the articles 64, 66, and 68 from the mounting assemblies 10. After use, the articles 64, 66, and 68 may be re-secured to the mounting assemblies 10. In general, the webbing mounting assemblies 10 are easy to attach to the webbings 60, and provide firm mounting structures for Picatinny weapon accessories.

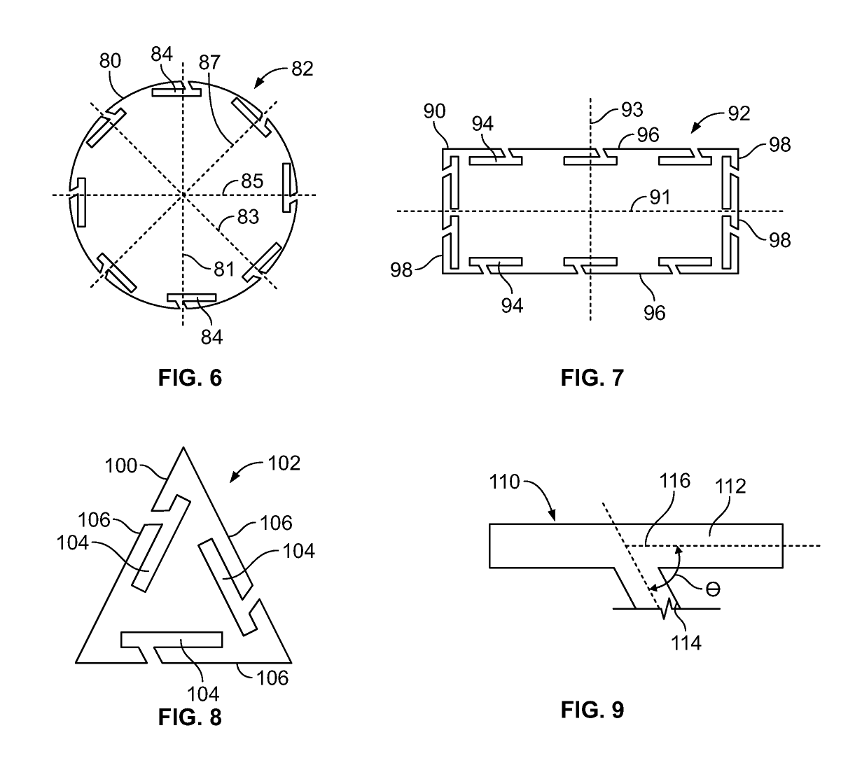

FIG. 6 illustrates an axial cross-sectional view of a base 80 of a webbing mounting assembly 82, according to an embodiment of the present disclosure. The base 80 may be circular having a plurality of webbing retainers 84 aligned with a plurality of axes 81, 83, 85, and 87. More or less webbing retainers 84 than those shown may be used.

FIG. 7 illustrates an axial cross-sectional view of a base 90 of a webbing mounting assembly 92, according to an embodiment of the present disclosure. The base 90 may be rectangular, having three webbing retainers 94 along each side 96, and two webbing retainers 96 along each end 98. However, more or less webbing retainers 94 may be along each side 96 and end 98. The webbing retainers 94 may be aligned with multiple axes 91 and 93 of the base 90. For example, the webbing retainers 94 along the sides 96 are aligned with the axis 93, while the webbing retainers 94 along the ends 98 are aligned with the axis 91.

FIG. 8 illustrates an axial cross-sectional view of a base 100 of a webbing mounting assembly 102, according to an embodiment of the present disclosure. The base 100 may be triangular, having a webbing retainer 104 along each side 106.

Referring to FIGS. 6-8, a webbing mounting assembly may be various shapes and sizes, including those not shown, such as hexagonal, octagonal, trapezoidal, or various irregular shapes. Each webbing mounting assembly may include one or more webbing retainers along its outer edges, sides, or the like. Different sets of webbing retainers may be aligned with different axes of the webbing mounting assembly. A set of webbing retainers may include first and second webbing retainers that are configured to retain different portions of the same webbing, for example.

FIG. 9 illustrates a top plan view of a webbing retainer 110, according to an embodiment of the present disclosure. As discussed above, the webbing retainer 110 includes a webbing-retaining slot 112 connected to an insertion channel 114. The insertion channel 114 may be positioned at an angle θ with respect to the webbing-retaining slot 112, as discussed above. The insertion channel 114 may connect to the webbing-retaining slot 112 proximate a mid-section 116 of the webbing-retaining slot 112. However, the insertion channel 114 may connect to the webbing-retaining slot 112 at various other portions, such as proximate one of the ends, or various points therebetween.

Referring to FIGS. 1-9, embodiments of the present disclosure provide a webbing-mounting assembly that is configured to be secured to a webbing, strap, or the like at various orientations. Thus, an individual may secure an article to the webbing mounting assembly at a desired location and orientation.

Embodiments of the present disclosure provide a webbing mounting assembly that allows for weapons-based Picatinny accessories to be mounted thereto, when the accessories are not in use on the weapon. For example, the webbing mounting assembly may be secured to webbing within a rucksack for example. A soldier may secure weapons accessories to the rucksack through the webbing mounting assembly. Moreover, in at least one embodiment, because the webbing mounting assembly includes webbing-receiving slots at more than two sides, the webbing mounting assembly may be longitudinally or laterally secured to the webbing, for example.

Embodiments provide a webbing mounting assembly that allows for easy storage of Picatinny weapon accessories, such as on a backpack, when not in use. In the past, when accessories were not in use, they were typically stored in a pocket. As such, different accessories jumbled together in a pocket would not always be quickly and easily found when needed. However, the webbing mounting assembly as shown and described allows a soldier to quickly and easily find a desired accessory as it remains in the location where the solider put it. In general, embodiments provide a firm mounting point for accessories so that they do not float around a pocket, bag, or the like.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

Various features of the disclosure are set forth in the following claims.

1. A webbing mounting assembly configured to secure an article to webbing, the webbing mounting assembly comprising:
a securing platform configured to securely retain the article; and
a base connected to the securing platform, the base including:
at least a first axis and a second axis that differs from the first axis;
at least a first set of webbing retainers aligned with the first axis; and
at least a second set of webbing retainers aligned with the second axis,
wherein the at least a first set of webbing retainers and the at least a second set of webbing retainers are configured to secure the article to the webbing in different orientations.

2. The webbing mounting assembly of claim 1, wherein each of the webbing retainers comprises an insertion channel connected to a webbing-retaining slot.

3. The webbing mounting assembly of claim 2, wherein the insertion channel is perpendicular to the webbing-retaining slot.

4. The webbing mounting assembly of claim 2, wherein the insertion channel connects to the webbing-retaining slot at an angle other than 90°.

5. The webbing mounting assembly of claim 1, wherein the securing platform comprises a plurality of alternating ridges and channels.

6. The webbing mounting assembly of claim 1, wherein the securing platform comprises a tactical rail.

7. The webbing mounting assembly of claim 1, wherein a first length of the base along the first axis differs than a second length of the base along the second axis.

8. The webbing mounting assembly of claim 1, wherein the base is rectangular.

9. A webbing mounting assembly configured to secure an article to webbing, the webbing mounting assembly comprising:
a securing platform configured to securely retain the article, wherein the securing platform comprises a tactical rail having a plurality of alternating ridges and channels; and
a base connected to the securing platform, the base including:
at least a first axis and a second axis that differs from the first axis, wherein a first length of the base along the first axis differs than a second length of the base along the second axis;
at least a first set of webbing retainers aligned with the first axis; and
at least a second set of webbing retainers aligned with the second axis, wherein each of the webbing retainers comprises an insertion channel connected to a webbing-retaining slot, and wherein the at least a first set of webbing retainers and the at least a second set of webbing retainers are configured to secure the article to the webbing in different orientations.

10. The webbing mounting assembly of claim 9, wherein the insertion channel is perpendicular to the webbing-retaining slot.

11. The webbing mounting assembly of claim 9, wherein the insertion channel connects to the webbing-retaining slot at an angle other than 90°.

12. The webbing mounting assembly of claim 9, wherein the base is rectangular.

13. A webbing mounting assembly configured to secure an article to webbing, the webbing mounting assembly comprising:
a base configured to retain a portion of the webbing, the base comprising:
at least a first axis and a second axis that differs from the first axis;
at least a first set of webbing retainers aligned with the first axis; and
at least a second set of webbing retainers aligned with the second axis, wherein the at least a first set of webbing retainers and the at least a second set of webbing retainers are configured to secure the article to the webbing in different orientations.

14. The webbing mounting assembly of claim 13, wherein each of the webbing retainers comprises an insertion channel connected to a webbing-retaining slot.

15. The webbing mounting assembly of claim 13, wherein the insertion channel is perpendicular to the webbing-retaining slot.

16. The webbing mounting assembly of claim 13, wherein the insertion channel connects to the webbing-retaining slot at an angle other than 90°.

17. The webbing mounting assembly of claim 1, wherein a first length of the base along the first axis differs than a second length of the base along the second axis.

18. The webbing mounting assembly of claim 1, wherein the base is rectangular.
